(19) United States
(12) Patent Application Publication
(10) Pub. No.: US 2012/0198773 A1
(43) Pub. Date: Aug. 9, 2012

(54) POSITIVE DRIVE FOR SLIDING GATE OPERATION

(75) Inventors: David Younce, Black Diamond, WA (US); Geoffrey M. Pate, Maple Valley, WA (US); Brian G. DeNault, Seattle, WA (US); Steven A. Carlsen, Bothell, WA (US)

(73) Assignee: Hy-Security Gate, Inc., Kent, WA (US)

(21) Appl. No.: 13/365,970

(22) Filed: Feb. 3, 2012

Related U.S. Application Data
(60) Provisional application No. 61/439,695, filed on Feb. 4, 2011.

(51) Int. Cl. E05F 15/14; E06B 5/00; H02K 7/116

(52) U.S. Cl. 49/359; 310/83; 49/358; 49/506

(57) ABSTRACT

A linear gate drive assembly with a drive rail connectable to a gate panel. A linear drive portion having a toothed drive surface is coupled to a first drive surface of the drive rail and has teeth thereon with a first rolling tooth profile. A drive wheel is attached to one drive motor and engages the first drive surface to impart an axial drive force on the drive rail. Another drive wheel is attached to another drive motor and engages the second drive surface. The second drive wheel has teeth that mate with the first teeth and that define another rolling tooth profile corresponding to the first rolling tooth profile. Rotation of the second drive wheel imparts axial and normal forces via a rolling teeth interface for moving the drive rail and the gate panel.

### CROSS-REFERENCE TO RELATED APPLICATIONS

The present application is a non-provisional patent application that hereby claims priority to U.S. Provisional Patent Application No. 61/439,695, titled Positive Drive for Sliding Gate Operation, filed Feb. 4, 2011, and which is incorporated herein by reference in its entirety.

### TECHNICAL FIELD

The invention relates generally to gate control devices, and more particularly, it relates to sliding gate systems and/or gate driving mechanisms for use with linear sliding types of gates (i.e. horizontal and vertical) and associated methods.

### BACKGROUND

The prior art includes numerous types of actuators and linkages for swinging type gates, and numerous devices for actuating pivoting gates as well as security barriers. One type of gate utilized in security perimeter protection is the sliding gate that can be operated open or closed by longitudinal sliding motion. These types of gates have been acted upon for their motive force by several means.

The most ubiquitous means of driving a sliding gate is with the use of a chain and sprocket arrangement wherein the ends of the chain are attached to the gate ends and wrapped around a sprocket on a gate driving motor. The chain drive has the disadvantage of requiring oiling to extend its service life and the inherent mess this makes when exposed to dirt. Further, the chains are limited in length due to sag, and stretch and wear only compound this drawback.

Another means of driving a sliding gate is rack and pinion drive, which utilizes an involute gear tooth pinion on the gate driving motor and a corresponding gear rack attached to the gate. These types of drives have the inherent disadvantage of requiring precise alignment between rack and pinion so as to not bind when the distance between rack and pinion vary, or require some means to hold the rack and pinion in intimate contact, which encourages wear in an involute gear. Further, again, these drives require lubrication to maintain their life. U.S. Pat. No. 5,261,187 to Prenger describes a spring loaded rack apparatus to attempt to get around the alignment problem, but does not address the contact issue. U.S. Pat. No. 5,515,650 to Machill describes a means of assembling a plastic rack into a channel and attaching it to the gate but does not address concerns over controlling the mesh between rack and pinion.

Yet another means of driving a sliding gate includes wheels clamped together onto a flat, relatively thin longitudinal drive member, and the arrangement utilizes frictional force generated by the clamping force and the coefficient of friction between wheel surfaces and the drive member. This means is illustrated in FIG. 2 which shows the wheels clamped upon a drive member. This means of driving a sliding gate works well with the exception of when said wheel and drive member get wet or encrusted in ice, slippage may occur when driving a heavy gate.

### SUMMARY

The present invention provides a gate driving assembly and related methods that overcome drawbacks experienced in the prior art and that provide other benefits. At least one embodiment provides a gate drive mechanism that requires no maintenance or lubrication, can be used on any length of gate, is unaffected by inconsistencies in alignment, and provides a positive drive so as to ensure high forces are transmitted to the gate in any weather conditions. The gate drive mechanism of the embodiment comprises a rolling tooth profile on a linear drive member and a corresponding rolling tooth profile on the drive wheel. In this manner, the concern for wear is gone due to the rolling nature of this tooth engagement, as opposed to the sliding nature of a typical involute gear tooth in a normal rack and pinion drive.

In an embodiment the gate drive mechanism can have the drive wheel mounted on a motor which is free to translate up and down while still transmitting the linear component of force needed to move the gate. The drive wheel and the linear drive member can be made of materials or a combination of materials that minimize wear and are inherently self lubricating and non-corroding.

In accordance with one aspect, the linear drive member comprises a molded plastic rolling tooth profile with means to slide this in sections into a correspondingly shaped aluminum extrusion in order to assemble the required length of drive to accommodate a given gate length. The drive wheel can be molded from a plastic such as polyurethane (PUR), thermoplastic vulcanite (TPV), or any other such tough, resilient plastic material. This material may be combined with some other material to form the hub of the drive wheel, such that a high strength hub is provided for structural purposes.

In at least one embodiment an idler wheel can be placed opposite the drive wheel on the other side of the linear drive member for the purpose of applying a consistent and predetermined normal force to the drive wheel. The idler wheel may be plain, or it may be a second toothed drive wheel.

One embodiment provides a linear gate drive assembly for use with a gate panel. The assembly can comprise a drive rail connectable to the gate panel, wherein the drive rail has a longitudinal axis and a first drive surface. A linear drive portion has a first plurality of teeth thereon with a first rolling tooth profile, wherein the linear drive portion is coupled to the first drive surface and defines a toothed second drive surface opposite the first drive surface. A support structure is adjacent to the drive rail, and the drive rail is moveable axially relative to the support structure. One or more drive motors is coupled to the support structure. A first drive wheel is attached to the one or more drive motors and is rotatable upon activation of the one or more drive motors. The first drive wheel engages the first drive surface and imparts a first drive force on the drive rail upon rotation of the first drive wheel to move the drive rail axially. A second drive wheel is attached to the one or more drive motors and engages the second drive surface. The second drive wheel has a plurality of second teeth disposed about a circumference, and the second teeth define a second rolling tooth profile that substantially corresponds to the first rolling tooth profile, wherein the second plurality of teeth mate with the first plurality of teeth. Rotation of the second drive wheel imparts axial and normal forces via a rolling teeth interface between the first and second teeth for driving the drive rail axially and moving the gate panel.

Another embodiment provides a security gate assembly. The security gate assembly can include a gate panel laterally movable between open and closed positions. A drive rail is fixed to the gate panel and is movable with the gate panel laterally between the open and closed positions. A linear drive portion can be attached to the drive rail and has a first plurality of teeth thereon that define a toothed second drive surface opposite the first drive surface. The first plurality of teeth define a first rolling tooth profile. One or more drive motors is coupled to a support structure, and a first drive wheel is rotatably attached to the one or more drive motors. The first drive wheel engages the first drive surface and imparts a first drive force on the drive rail upon rotation of the first drive wheel to move the drive rail and gate panel laterally. A second drive wheel is attached to the one or more drive motors and engages the second drive surface. The second drive wheel can have a plurality of second teeth disposed about a circumference and that define a second rolling tooth profile substantially corresponding to the first rolling tooth profile, wherein the second plurality of teeth mate with the first plurality of teeth, and wherein rotation of the second drive wheel imparts axial and normal forces via a rolling teeth interface between the first and second teeth for driving the drive rail axially and moving the gate panel between the open and closed positions.

Another embodiment provides a method of forming a security gate assembly. The method can include attaching a drive rail to a gate panel, wherein the drive rail has a longitudinal axis and a first drive surface. The method can include attaching a linear drive portion to the drive rail, wherein the linear drive portion has a first plurality of teeth thereon with a first rolling tooth profile. The linear drive portion defines a toothed second drive surface opposite the first drive surface. The method can include attaching first and second drive assemblies to a support structure adjacent to the drive rail, wherein the drive rail and gate panel are moveable as a unit laterally relative to the support structure. The first drive assembly can have a first drive motor and first drive wheel pivotally coupled to the support structure. The second drive assembly can have a second drive motor and second drive wheel pivotally coupled to the support structure. The first drive wheel engages the first drive surface and imparts a first drive force on the drive rail upon rotation of the first drive wheel to move the drive rail axially. The second drive wheel engages the second drive surface. The second drive wheel has a plurality of second teeth disposed about a circumference and that have a second rolling tooth profile substantially corresponding to the first rolling tooth profile. The second plurality of teeth mates with the first plurality of teeth. Rotation of the second drive wheel imparts axial and normal forces via a rolling teeth interface between the first and second teeth for driving the drive rail axially and moving the gate panel.

### BRIEF DESCRIPTION OF THE DRAWINGS

FIG. 1 is a view of a sliding gate system in accordance with an embodiment of the present invention.

FIG. 2 is a view of a prior art drive system.

FIG. 3 is an isometric view of a drive system of the sliding gate system of FIG. 1.

FIG. 4 is an enlarged side elevation view of a portion of the drive system of FIG. 3.

FIG. 5 is a sectional view taken substantially along line 5-5 of FIG. 3.

FIG. 6 is an enlarged schematic side elevation view of a rolling tooth profile drive of an embodiment.

FIG. 7 is an enlarged schematic side elevation view of a tooth profile arrangement of another embodiment.

FIG. 8 is a sectional view of an extruded gate drive rail with a linear drive member inserted in accordance with an embodiment of the present disclosure.

### DETAILED DESCRIPTION

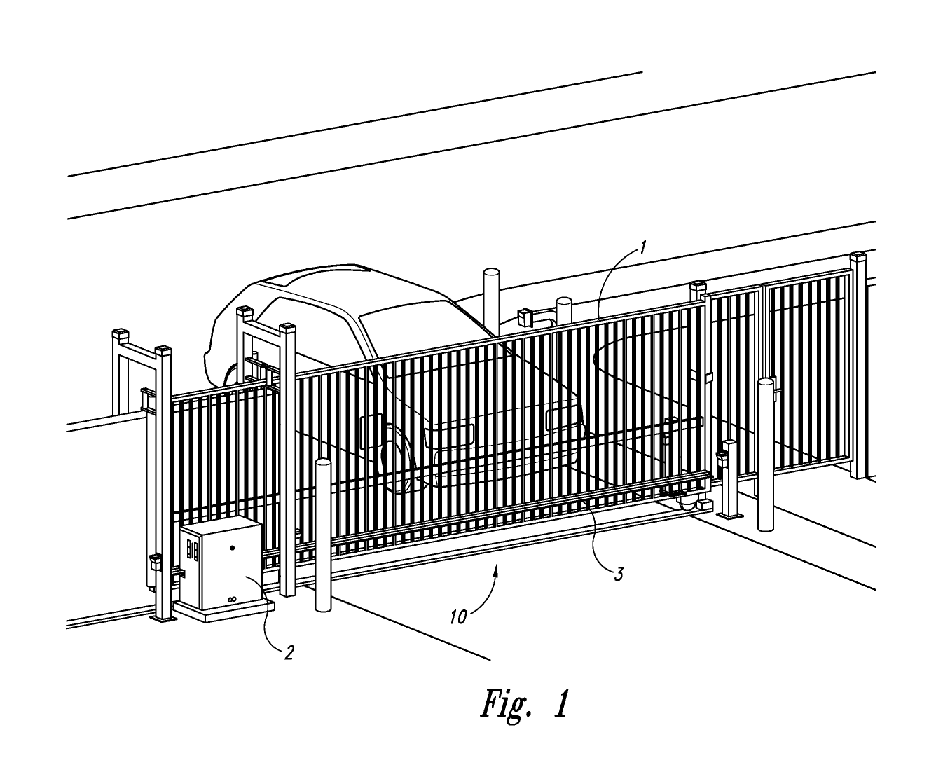

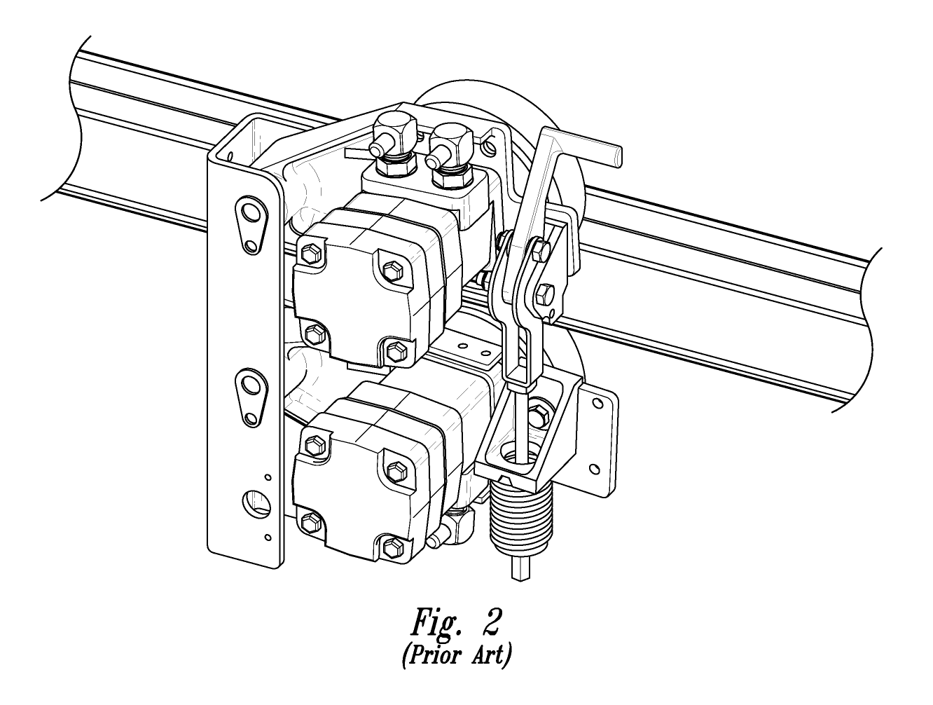

Sliding gate systems, associated drive systems, and related methods are described in detail herein in accordance with embodiments of the present disclosure. The systems and associated assemblies and/or features overcome drawbacks experienced in the prior art and provide other benefits. Certain details are set forth in the following description and in FIGS. 1-8 to provide a thorough and enabling description of various embodiments of the disclosure. Other details describing well-known structures and components often associated with gate assemblies and associated with forming such assemblies, however, are not set forth below to avoid unnecessarily obscuring the description of various embodiments of the disclosure. Many of the details, dimensions, angles, relative sizes of components, and/or other features shown in the Figures are merely illustrative of particular embodiments of the disclosure. Accordingly, other embodiments can have other details, dimensions, angles, sizes, and/or features without departing from the spirit and scope of the present disclosure. In addition, further embodiments of the disclosure may be practiced without several of the details described below, while still other embodiments of the disclosure may be practiced with additional details and/or features. In the Figures, identical reference numbers identify identical, or at least generally similar, elements. Moreover, one of ordinary skill in the art will appreciate that any relative positional terms such as above, below, over, under, etc. do not necessarily require a specific orientation of the footwear assemblies as described herein. Rather, these or similar terms are intended to describe the relative position of various features of the disclosure described herein.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

References throughout the specification to “one embodiment” or “an embodiment” means that a particular feature, structure, or characteristic described in connection with the embodiment and included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

As seen in FIG. 1, a sliding gate system 10 consists of a gate panel 1 which contains a drive rail 3 securely fastened to the gate, and a gate operating device 2 that may be attached to a concrete pad or to a secondary structure for support.

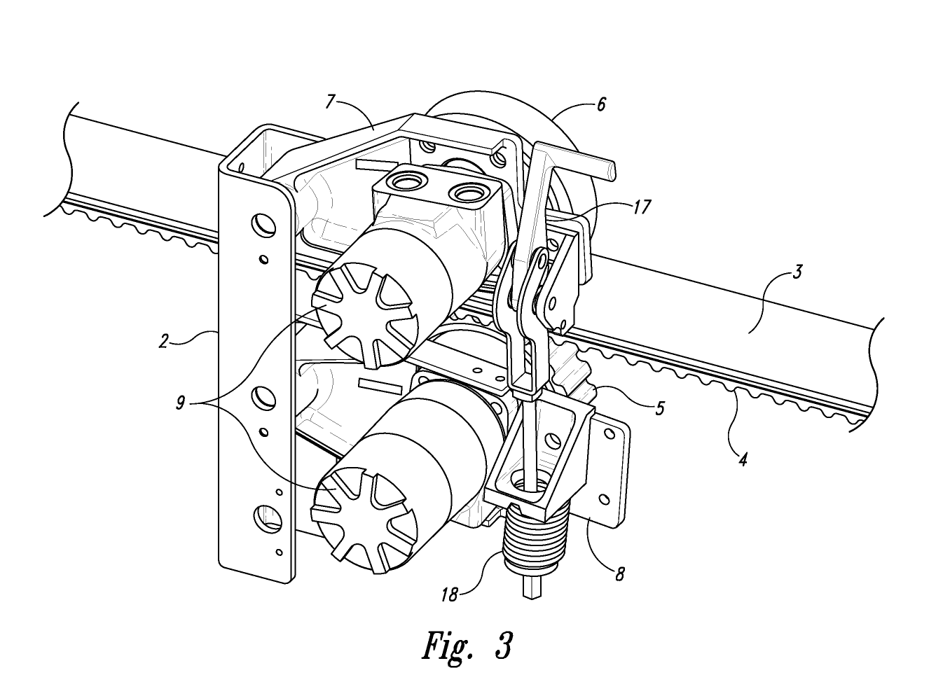

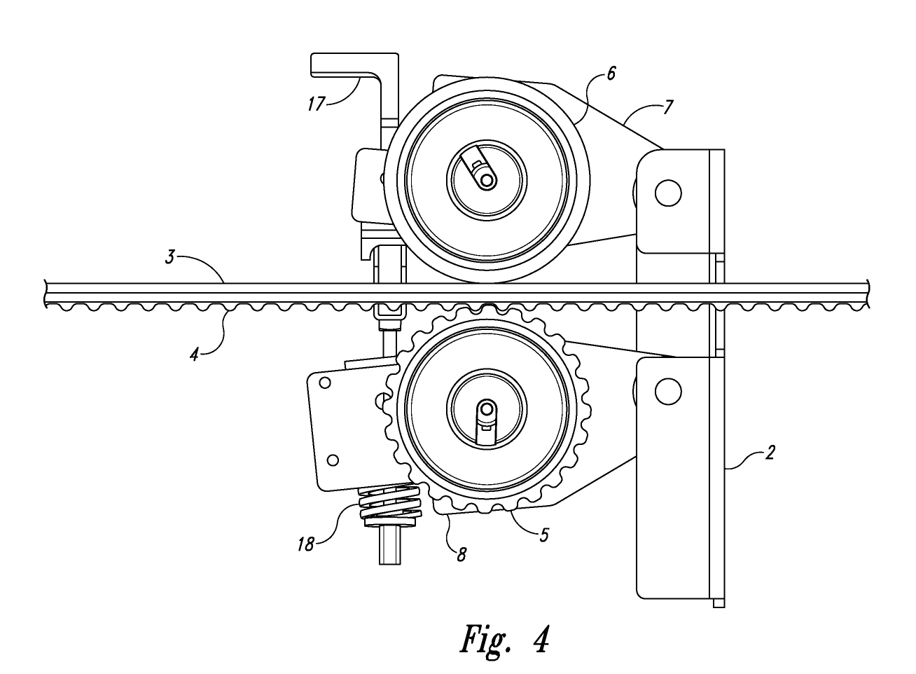

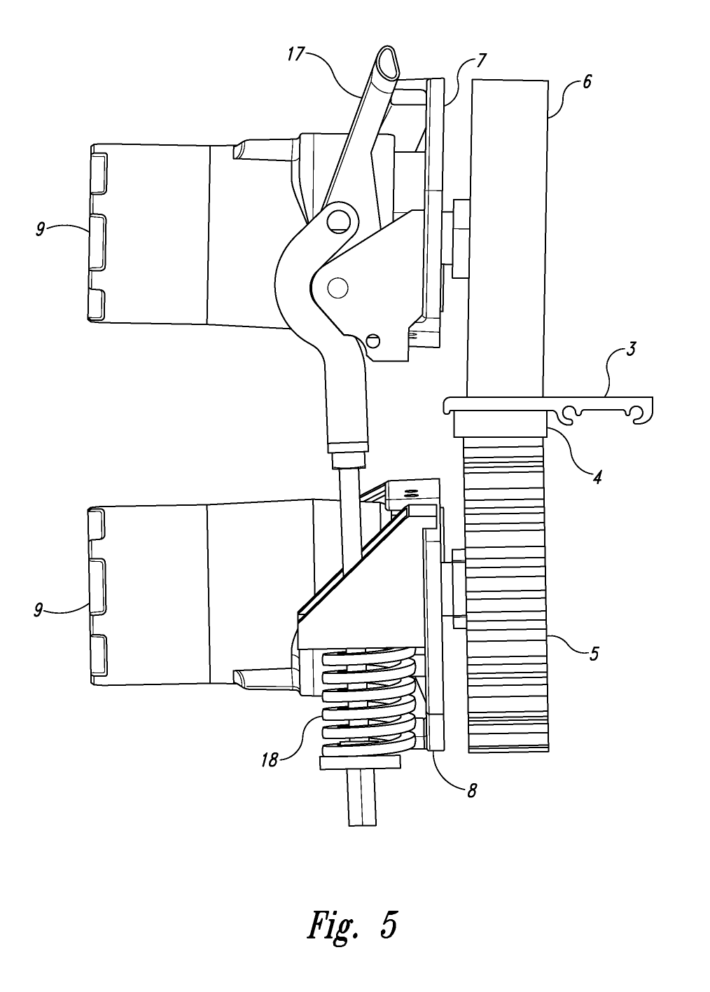

Referring to FIG. 3, FIG. 4 and FIG. 5, in the illustrated embodiment, a linear drive member 4 having drive teeth 13 thereon is fixed to the drive rail 3. An upper drive wheel 6 is attached to a drive motor 9. This combination of wheel and motor is then mounted in upper drive arm 7. It should be noted here that this method of drive is equally effective where the motor 9 is replaced with any of a variety of geared speed reducers or other power transmission means which support a rotary application of torque to the drive wheel.

A toothed drive wheel 5 having drive teeth 15 thereon is attached to a second drive motor 9. This combination of the toothed drive wheel 5 and lower drive motor 9 is mounted in a lower drive arm 8. The teeth 15 of the toothed drive wheel 5 are engaged with the teeth 13 of the linear drive member 4.

The upper drive arm 7 and the lower drive arm 8 are rotatably connected to the gate operating device 2, such as to a support frame, in a configuration so the upper and lower drive arms 7 and 8 can rotate relative to the support frame, thereby allowing the upper and lower drive wheels 6 and 5 to translate in a roughly vertical curvilinear path. This arrangement allows for any inconsistency in the straightness and level of the horizontal drive rail 3 as the gate panel 1 (FIG. 1) translates horizontally along its path. It should be noted that any number of substantially equivalent means of allowing the combination of drive wheels and motors to translate essentially vertically while still providing reaction to the horizontal force of moving the gate could be used.

The upper drive arm 7 and the lower drive arm 8 are held together with toggle clamp 17 and spring 18. This arrangement of the toggle clamp 17 and spring 18 provide a constant and predictable force that squeezes the upper drive wheel 6 and the toothed drive wheel 5 together thus supplying a normal force N between the upper drive wheel 6 and the horizontal drive rail 3 and between the toothed drive wheel 5 and the linear drive member 4. The toggle claim 17 and the spring 18 are coupled to the upper and lower drive arms 7 and 8, so as to effectively tie the upper drive wheel 6 to the lower toothed drive wheel 5. Accordingly, the drive wheels 6 and 5 will translate in unison in the event of vertical motion of the wheels relative to the support frame. This means that the drive wheels 6 and 5 will always remain in firm engagement with the drive rail 3 and linear drive member 4, respectively, while the toggle clamp is in the engaged position.

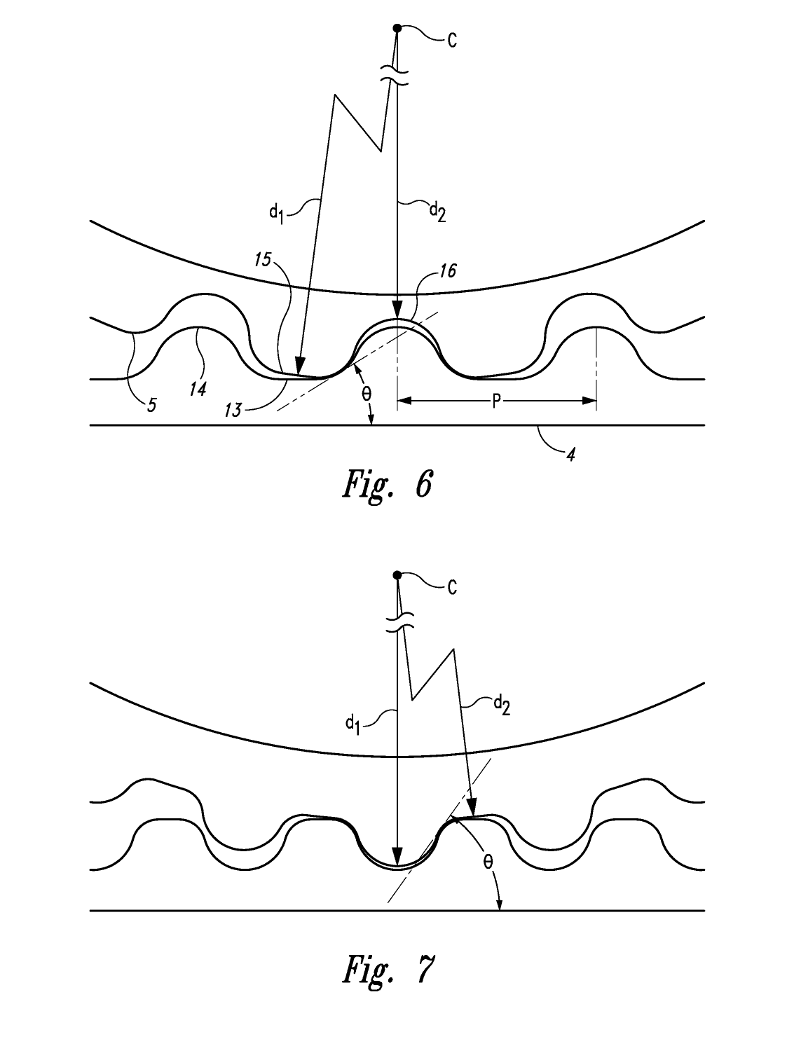

Referring to FIG. 6 is a close up view of the engagement of a section of the linear drive member 4 engaged with the portion of a toothed drive wheel 5. On the linear drive member 4, the root of the tooth 13 is formed as a substantially circular shape. The crest of the tooth 15 on the toothed drive wheel 5 is formed as a substantially corresponding circular shape, and engaged such that the crest of the tooth 15 may roll freely on the root of the tooth 13 of the linear drive member 4. In a linear fashion, at a distance of half the pitch p along the linear drive member 4, a crest of the tooth 14 is formed in a substantially circular shape. While the example described above refers to a substantially circular shape, other arcuate shapes, such as truly circular, ellipsoid, or any generally curvilinear shape, could be used as long as it facilitates rolling between the crest of the teeth on the drive wheel and the root of the teeth of the linear drive member.

A pressure angle θ is defined by the angle of the tangent point where the curvilinear portion of the tooth meets the curvilinear portion of the root. Hence there is a portion of torque which is transferred along the direction of the linear drive member and a portion which is imparted normal to the direction of the linear drive member. The horizontal portion is given by Fh=F Sin θ and the normal portion is given by Fn=F Cos θ.

In addition to the motive force provided by the pressure angle of the tooth, significant force is imparted from the upper drive wheel 6 to the horizontal drive rail 3 through pure friction. In this case, the frictional force is given by F=μN, where μ is the coefficient of friction between the material of the upper drive wheel 6 and the horizontal drive rail 3.

A likewise effect is had from the frictional interface between the toothed drive wheel 5 and the linear drive member 4. For this reason it is desirable to make the mating surface of both the upper drive wheel and the toothed drive wheel from a material that exhibits high friction versus the materials they bear against.

In operation, the toothed drive wheel 5 rolls on a tooth 15 of the wheel, then transfers to rolling on a tooth 13 of the linear drive member 4, then back to rolling on the wheel 5, etc.

As shown in FIG. 6, the distance dl from the center of the toothed drive wheel, c to the crest of the tooth 15 is larger than the distance d2 from the center to the root of the next tooth 16. This difference in distance causes a variation in the speed that the linear drive member 4 travels given a fixed rotational speed of the toothed drive wheel 5. Thus the average speed is based on the average radius from the center of the toothed drive wheel c. One way of minimizing this variation is to utilize a lower pressure angle. This approach is shown in FIG. 7, where the pressure angle θ is relatively small. This leads to a relatively smaller difference between d1 and d2 although as noted above, the horizontal component of drive is smaller and the normal component of drive is larger, which may be undesirable.

The material for the toothed drive wheel 5 as well as the upper drive wheel 6 of an embodiment can have high coefficients of friction, low wear, wide temperature range, compliance to debris, and require no lubrication. These properties are available in a range of polymer compounds, for example polymers that are commonly injection molded such as acrylinitrile butadiene styrene (ABS), polycarbonate (PC), polyester (PES), polyethylene (PE), polystyrene (PS), acetal, polyamides (PA), polypropylene (PP), Polyvinyl chloride (PVC). These properties could also be achieved using molded rubbers, polyurethane (PU), thermoplastic vulcanate (TPV), or thermoplastic urethane (TPU). Other embodiments could use other suitable materials.

The material for the linear drive member 4 likewise can include the properties of high coefficient of friction, low wear, wide temperature range, compliance to debris, and require no lubrication. These properties are available in a range of polymer compounds, for example polymers that are commonly injection molded such as acrylinitrile butadiene styrene (ABS), polycarbonate (PC), polyester (PES), polyethylene (PE), polystyrene (PS), acetal, polyamides (PA), polypropylene (PP), Polyvinyl chloride (PVC). These properties could also be achieved using molded rubbers, polyurethane (PU), thermoplastic vulcanate (TPV), or thermoplastic urethane (TPU). Other embodiments could use other suitable materials.

Another embodiment utilizes instead of a motor driving the upper drive roller, one or more unpowered idler rollers on the opposite side of the linear drive member 4 supported by bearing means with the sole purpose to apply a normal clamping force to the toothed drive wheel 5. In yet another embodiment, the gate drive assembly 10 uses a toothed drive wheel with the rolling tooth profile as described above that engages the teeth on the linear drive, with out using the other drive motor and drive wheel. In this alternate embodiment, the linear drive portion can be attached directly to a rigid portion of the gate panel. The toothed drive wheel can be attached to motor assembly carried by a drive arm spring loaded against the toothed drive surface. Alternatively, the toothed drive wheel can be held rigidly in a relationship to the portion of the gate with the toothed drive surface.

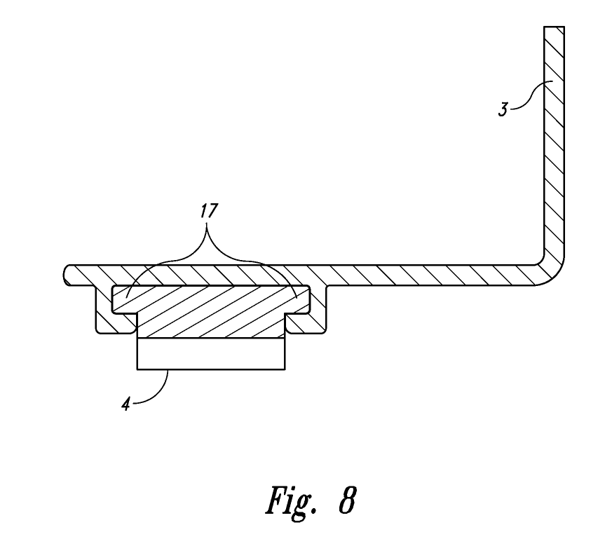

In another aspect of the invention, as shown in FIG. 8, the linear drive member 4 and the drive rail 3 can be equipped with an interlocking feature 17 (of which this is just one example of) whose purpose is to hold the linear drive member from moving in all but the drive direction.

A particular embodiment of the gate assembly comprises a sliding gate, a gate operating device containing a motor, and a gate drive mechanism. The gate drive mechanism of this embodiment comprises a linear drive member with a rolling tooth profile and a drive wheel attached to the output shaft of the motor. Additionally, the drive wheel includes a rolling tooth profile that corresponds to the tooth profile on the linear drive member to which it is rotatably in contact with.

In one embodiment the motor may be constrained in the longitudinal direction and not in the vertical direction. Additionally, the motor may be mounted on an arm rotatably attached to the gate operating device.

A second motor and drive wheel may be included to drive the opposite side of the longitudinal drive member. This drive wheel may include a rolling tooth profile corresponding to a rolling tooth profile on the linear drive member with which it is rotatably in contact. Alternatively, the drive wheel on the second motor may be a conventional round drive wheel. Furthermore, one or more unpowered idler rollers may be included on the opposite side of the linear drive member.

The linear drive member or the drive wheel, or both, may be constructed from a polymeric material, such as polyurethane. Additionally, the linear drive member may be of a certain length such that when placed end to end, the pitch of the rolling tooth profile is maintained. Finally, linear drive members may be of such length that when inserted into a correspondingly shaped gate drive rail extrusion, the lengths are restrained from movement in any but the longitudinal direction.

Those skilled in the art will recognize that this drive method can apply to other barriers requiring linear motion to open and close them, and the orientation is not important.

From the foregoing, it will be appreciated that specific embodiments of the invention have been described herein for purposes of illustration, but that various modifications may be made without deviating from the spirit and scope of the invention. Additionally, aspects of the invention described in the context of particular embodiments or examples may be combined or eliminated in other embodiments. Although advantages associated with certain embodiments of the invention have been described in the context of those embodiments, other embodiments may also exhibit such advantages. Additionally not all embodiments need necessarily exhibit such advantages to fall within the scope of the invention.

I claim:

1. A linear gate drive assembly for use with a gate panel, comprising:
a drive rail connectable to the gate panel, the drive rail having a longitudinal axis and a first drive surface;
a linear drive portion having a first plurality of teeth thereon with a first rolling tooth profile, the linear drive portion being coupled to the first drive surface and defining a toothed second drive surface opposite the first drive surface;
a support structure adjacent to the drive rail, wherein the drive rail is moveable axially relative to the support structure;
one or more drive motors coupled to the support structure;
a first drive wheel attached to the one or more drive motors and being rotatable upon activation of the one or more drive motors, the first drive wheel engaging the first drive surface and imparting a first drive force on the drive rail upon rotation of the first drive wheel to move the drive rail axially; and
a second drive wheel attached to the one or more drive motors and engaging the second drive surface, the second drive wheel having a plurality of second teeth disposed about a circumference and that have a second rolling tooth profile substantially corresponding to the first rolling tooth profile, wherein the second plurality of teeth mate with the first plurality of teeth, wherein rotation of the second drive wheel imparts axial and normal forces via a rolling teeth interface between the first and second teeth for driving the drive rail axially and moving the gate panel.

2. The assembly of claim 1 wherein the one or more drive motors is carried by a drive arm pivotally attached to the support structure.

3. The assembly of claim 1 wherein the one or more drive motors comprises a first drive motor operatively attached to the first drive wheel, and a second drive motor operatively attached to the second drive wheel, activation of the first drive motor rotates the first drive wheel relative to the first drive surface and activation of the second drive motor rotates the second drive wheel relative to the second drive surface.

4. The assembly of claim 3, further comprising a first drive arm carrying the first drive motor, and a second drive arm carrying the second drive motor, the first and second drive arms being pivotally attached to the support structure.

5. The assembly of claim 1 wherein the first and second drive wheels are movable in unison relative to the support structure along a substantially vertical curvilinear path while maintaining driving engagement with the first and second drive surfaces.

6. The assembly of claim 5 wherein the first and second drive wheels are substantially constrained from additional motion parallel to a longitudinal axis of the drive rail.

7. The assembly of claim 1 wherein the linear drive portion is a linear drive member attached directly to the drive rail.

8. The assembly of claim 1 wherein the liner drive portion comprises a plurality of separable interconnected segments extending end-to-end and parallel to the drive rail.

9. The assembly of claim 1 wherein drive rail comprises a receiving portion that removably carries at least a portion of the linear drive portion, wherein the first and second teeth project in opposite directions away from each other.

10. The assembly of claim 1 further comprising a clamp member holding the first and second drive wheels in direct engagement with the first and second drive surfaces, respectively, wherein the drive rail and liner drive portion are clamped between the first and second drive wheels.

11. The assembly of claim 1 wherein the first teeth each have a substantially arcuate first drive portion that define the first rolling tooth profile, and the teeth each have a substantially arcuate second drive portions that define the second rolling tooth profile that mates with the first rolling tooth profile.

12. The assembly of claim 1 wherein the first teeth each have a substantially arcuate first crest portion and a substantially arcuate first root portion, and the second teeth each have a substantially arcuate second crest portion and a substantially arcuate second root portion, wherein the first crest portion of a first tooth on the toothed second drive surface rolls along the second root portion of an adjacent second tooth on the second drive wheel upon rotation of the drive wheel, and the second crest portion of the second tooth on the second drive wheel rolls along the first root portion of the first tooth on the toothed second drive surface to impart axial and normal forces for driving the drive rail axially.

13. The assembly of claim 12 wherein the arcuate first and second drive portions have mating, partially circular shapes.

14. The assembly of claim 1, further comprising one or more unpowered idle rollers disposed adjacent to the drive rail and in engagement with the first drive surface.

15. A security gate assembly, comprising:
a gate panel laterally movable between open and closed positions;
a drive rail fixed to the gate panel and movable with the gate panel laterally between the open and closed positions, the drive rail having a first drive surface;
a linear drive portion having a first plurality of teeth thereon with a first rolling tooth profile, the linear drive portion being coupled to the first drive surface and defining a toothed second drive surface opposite the first drive surface;
a support structure adjacent to the drive rail, wherein the drive rail is moveable laterally relative to the support structure;
one or more drive motors coupled to the support structure;
a first drive wheel attached to the one or more drive motors and being rotatable upon activation of the one or more drive motors, the first drive wheel engaging the first drive surface and imparting a first drive force on the drive rail upon rotation of the first drive wheel to move the drive rail axially; and
a second drive wheel attached to the one or more drive motors and engaging the second drive surface, the second drive wheel having a plurality of second teeth disposed about a circumference and that have a second rolling tooth profile substantially corresponding to the first rolling tooth profile, wherein the second plurality of teeth mate with the first plurality of teeth, wherein rotation of the second drive wheel imparts axial and normal forces via a rolling teeth interface between the first and second teeth for driving the drive rail axially and moving the gate panel.

16. The assembly of claim 15 wherein the one or more drive motors comprises a first drive motor operatively attached to the first drive wheel, and a second drive motor operatively attached to the second drive wheel, activation of the first drive motor rotates the first drive wheel relative to the first drive surface and activation of the second drive motor rotates the second drive wheel relative to the second drive surface.

17. The assembly of claim 16, further comprising a first drive arm carrying the first drive motor, and a second drive arm carrying the second drive motor, the first and second drive arms being pivotally attached to the support structure.

18. The assembly of claim 15 wherein the first and second drive wheels are movable in unison relative to the support structure along a substantially vertical curvilinear path while maintaining driving engagement with the first and second drive surfaces and the first and second drive wheels are substantially constrained from additional motion parallel to a longitudinal axis of the drive rail.

19. The assembly of claim 15 wherein drive rail comprises a receiving portion that removably carries at least a segment of the linear drive portion, wherein the first and second teeth project in opposite directions away from each other.

20. The assembly of claim 1 further comprising a clamp member holding the first and second drive wheels in direct engagement with the first and second drive surfaces, respectively, wherein the drive rail and liner drive portion are clamped between the first and second drive wheels.

21. The assembly of claim 15 wherein the first teeth each have a substantially circular first crest portion and a substantially circular first root portion, and the second teeth each have a substantially circular second crest portion and a substantially circular second root portion, wherein the first crest portion of a first tooth on the toothed second drive surface rolls along the second root portion of an adjacent second tooth on the second drive wheel upon rotation of the drive wheel, and the second crest portion of the second tooth on the second drive wheel rolls along the first root portion of the first tooth on the toothed second drive surface to impart axial and normal forces for driving the drive rail axially.

22. The assembly of claim 15, further comprising one or more unpowered idle rollers in engagement with the first or second drive surface.

23. The assembly of claim 15 wherein the plurality of second teeth second teeth are made of a polymeric material.

24. The assembly of claim 23 wherein the polymeric materials is polyurethane.

25. A method of forming a security gate assembly, comprising:
attaching a drive rail to a gate panel, the drive rail having a longitudinal axis and a first drive surface;
attaching a linear drive portion to the drive rail, the linear drive portion having a first plurality of teeth thereon with a first rolling tooth profile, the linear drive portion being coupled to the first drive surface and defining a toothed second drive surface opposite the first drive surface; and
attaching first and second drive assemblies to a support structure adjacent to the drive rail, wherein the drive rail and gate panel are moveable as a unit laterally relative to the support structure, the first drive assembly having a first drive motor and first drive wheel pivotally coupled to the support structure, and the second drive assembly having a second drive motor and second drive wheel pivotally coupled to the support structure, the first drive wheel engaging the first drive surface and imparting a first drive force on the drive rail upon rotation of the first drive wheel to move the drive rail axially, and the second drive wheel engaging the second drive surface, the second drive wheel having a plurality of second teeth disposed about a circumference and that have a second rolling tooth profile substantially corresponding to the first rolling tooth profile, wherein the second plurality of teeth mate with the first plurality of teeth, wherein rotation of the second drive wheel imparts axial and normal forces via a rolling teeth interface between the first and second teeth for driving the drive rail axially and moving the gate panel.

26. The method claim 25, further comprising clamping the first and second drive assemblies together with the drive rail and the linear drive member being clamped between the first and second drive wheels.

27. The method of claim 25, further comprising allowing the first and second drive assemblies to move as a unit along a substantially vertical curvilinear path relative to the support structure.

28. The method of claim 27, further comprising constraining the first and second drive assemblies from additional lateral movement relative the support structure while substantially allowing the first and second drive assemblies to move along the substantially vertical curvilinear path.

29. A linear gate drive assembly for use with a gate panel, comprising:
an elongated drive rail connectable to the gate panel, the drive rail having a longitudinal axis and opposing first and second surfaces, the first surface defining a first drive surface;
a gate operating device adjacent to the drive rail, the gate operating device having a support structure;
a first drive arm pivotally connected to the support structure and being pivotal relative to the support structure in a pivot plane substantially perpendicular to the first surface of the drive rail;
a second drive arm pivotally connected to the support structure and being pivotal relative to the support structure in the pivot plane;
a first drive motor attached to the first drive arm and being pivotal with the first drive arm as a unit relative to the support structure;
a second drive motor attached to the second drive arm and being pivotal with the second drive arm as a unit relative to the support structure;
a linear drive member having a first plurality of teeth thereon, the linear drive member being attached to the drive rail and defining a toothed drive surface opposite the first drive surface with the first plurality of teeth projecting away from first drive surface, the first plurality of teeth being oriented substantially perpendicular to the longitudinal axis of the drive rail, the first plurality of teeth defining substantially arcuate first drive portions of the toothed drive surface, and each of the first plurality of teeth having a substantially arcuate first crest portion and a substantially arcuate first root portion;
a first drive wheel attached to the first drive motor and engaging the first drive surface, wherein the first drive wheel rotates upon activation of the first drive motor and rotation of the first drive wheel and the engagement with the first drive surface imparts a first drive force on the drive rail to move the drive rail in a direction substantially parallel to the longitudinal axis of the drive rail, the first drive wheel, the first drive motor and the first drive arm being pivotable as a first unit relative to the support structure; and
a second drive wheel attached to the second drive motor and engaging the toothed drive surface of the linear drive member, the second drive wheel having a second plurality of second teeth thereon disposed about a circumference, wherein the second plurality of teeth mate with the first plurality of teeth being are oriented substantially perpendicular to the longitudinal axis of the drive rail, the second plurality of teeth defining substantially arcuate second drive portions that mate with the first drive portions, each of the second plurality of teeth having a substantially arcuate second crest portion and a substantially arcuate second root portion, wherein upon rotation of the second drive wheel the first crest portion of the tooth on the toothed drive surface rolls along the second root portion of an adjacent tooth on the second drive wheel, and the second crest portion of a tooth on the second drive wheel rolls along the first root portion of a tooth on the toothed drive surface to impart axial and normal forces for driving the drive rail longitudinally to move the gate panel between open and closed position; and
a clamp assembly connected to the first and second drive arms and applying normal forces between the first drive wheel and the drive surface and between the second drive wheel and the linear drive member.
